(19) United States
(12) Patent Application Publication
(10) Pub. No.: US 2015/0154717 A1
(43) Pub. Date: Jun. 4, 2015

(54) Leveraging Transaction data for Entity Verification and Credibility

(71) Applicant: Credibility Corp., Malibu, CA (US)

(72) Inventors: Jeffrey M. Stibel, Malibu, CA (US); Raymond Landgraf, Los Angeles, CA (US); Peter Delgrosso, Malibu, CA (US)

(73) Assignee: Credibility Corp., Malibu, CA (US)

(21) Appl. No.: 14/188,923

(22) Filed: Feb. 25, 2014

Related U.S. Application Data
(60) Provisional application No. 61/911,407, filed on Dec. 3, 2013.

(51) Int. Cl. G06Q 40/00

(52) U.S. Cl. CPC G06Q 40/12

(57) ABSTRACT

Some embodiments provide an accurate and real-time account of an entity's verification status and credibility from transaction data. Some embodiments verify the entity's operational status by aggregating transaction data involving the entity and by determining if the transaction data satisfies some threshold number of transactions within a given time frame. If the threshold is satisfied, the entity is verified to be active and operational and have a “pulse”. The pulse can be used to scrub directories or marketing lists. Some embodiments derive the entity's credibility by monitoring for increases or decreases in the transaction data, wherein increases or decreases can be identified from changes in the transaction volume, changes in average transaction price, and/or changes in price of a good or service from one monitored interval to another. Some embodiments derive entity credibility by comparing those changes to changes in one or more competitors' transaction data.

### CLAIM OF BENEFIT TO RELATED APPLICATION

This application claims the benefit of U.S. provisional application 61/911,407 entitled “Leveraging Transaction Data for Entity Verification and Credibility”, filed Dec. 3, 2013. The contents of application 61/911,407 are hereby incorporated by reference.

### TECHNICAL FIELD

The present invention pertains to entity verification and entity credibility.

### BACKGROUND

Verification and credibility play a key role in guiding how business is conducted. Among other things, verification is essential for knowing that the entity being transacted with is active and operational. For instance, when seeking an entity to provide a service, verification ensures that the entity does in fact provide such a service. Verification also identifies that the entity being transacted with is who it claims to be and not someone impersonating another. Credibility gauges whether or not to engage in a transaction with another. Generally, credibility is some measure of reputation, trustworthiness, timeliness, responsiveness, quality, and/or other factors that one entity considers important when engaging with another. Thus, first and second entities may be verified to provide a complimentary service. However, one may prefer transacted with the first entity over the second entity when the first entity has better credibility than the second entity and can therefore be better trusted to satisfy its obligations in the transaction.

However, verification and credibility are each subject to continual change. With respect to entity verification, entities come into and out of business everyday, some open new locations, some close poorly performing locations, others merge, change identities, etc. Accordingly, the verification status of an entity can quickly change and become obsolete if such changes are not immediately accounted for. With respect to entity credibility, each experience that an entity has with another has the potential of impacting that entity's credibility. These experiences can be captured in reviews that are posted to various online review sites. A succession of positive experiences improves one's credibility, whereas a succession of negative experiences decreases one's credibility. In addition, credibility continually shifts as new goods and services are offered, strategic changes are implemented, and personnel changes are made among many other daily activities. As with an entity's verification status, entity credibility can quickly become obsolete if experiences reflecting these continual changes are not accounted for. In other words, reviews that are a few weeks old and that are used in deriving credibility may portray a picture of an entity as it was in the past and not how it exists in the present.

Therefore, if verification and credibility information is to be meaningful, it must be continually updated, ideally as the changes happen. Obsolete or lagging entity verification and credibility can delay or otherwise mask the dissemination of accurate information about an entity. Worse yet, obsolete verification status and credibility can provide an inaccurate and misleading representation of an entity. This can lead to undeserved impact to the entity's business. Moreover, it can be harder for an entity to change its verified status and/or credibility if others are slow to propagate and disseminate those changes.

Another issue with prior art approaches to verification and credibility is that they can be easily gamed. In many cases, the prior art derives an entity's verification status and credibility from subjective data rather than objective data. For instance, fake reviews can be posted to a review site in an attempt to improperly change one's credibility.

To address these and other shortcomings, there is a need for systems and methods that provide real-time and accurate accounts of an entity's verification status and credibility. There is further a need for systems and methods that derive verification status and credibility in an objective manner using objective data, such that the results cannot be manipulated or gamed.

### SUMMARY OF THE INVENTION

It is an objective of the present invention to define systems, methods, and computer software products to provide an accurate and real-time account of an entity's verification status and credibility. To this end, it is an objective to leverage objective and real-time transaction data for the purpose of verifying entity status and deriving entity credibility.

In accordance with these and other objectives, some embodiments implement a transaction driven verification and credibility system. In such a system, the verification status and credibility of an entity are derived from transaction data to which the entity is a party.

First, the system aggregates transaction data. The transaction data includes credit card transaction data and may also include transactions conducted using wire transfers and other forms of payment. Depending on the source, the transaction data can minimally identify the buyers or sellers of a transaction. More detailed transaction data identifies both parties to a transaction, the transaction amount, itemized listings of goods and services associated with a transaction, seller information, etc.

The system verifies the operational status of each of a plurality of entities using the aggregated transaction data. To do so, the system looks to the transaction data to determine if a particular entity has a “pulse”. The particular entity has a pulse, whereby it is deemed active and operational, when the particular entity satisfies some pulse criteria. The pulse criteria can require the particular entity to be involved in some threshold number of transactions in a given time frame (e.g., at least one transaction processed in a day) or some continuous stream of regularly occurring transactions in a repeating interval. In some embodiments, the pulse criteria are modified depending on the entity being verified. Larger entities may be verified using a different set of pulse criteria than that used for verifying smaller entities. Background information about a given entity can be obtained from an entity database. This background information specifies, among other things, the entity's size, revenue, goods or services, etc. By regularly aggregating and processing the transaction data, the system can maintain a real-time pulse for each of the plurality of entities.

If from the transaction data, the system determines that a particular entity does not have a pulse (i.e., the transaction data involving that particular entity does not satisfy the pulse criteria set for that particular entity), the system lists that particular entity's status as unverified. In other words, the system cannot verify the particular entity to be active and operational.

If from the transaction data, the system determines that the particular entity does have a pulse (i.e., the transaction data involving that particular entity satisfies the pulse criteria set of that particular entity), the system lists that the particular entity's status as verified. In other words, the system verifies that the particular entity is active and operational.

The direct application of the pulse or verified entity status is to inform others about the operational status of a desired entity. Other direct applications involve verifying information about an entity including, for example, a geographic region or address from which the entity operates, size of the entity, annual, monthly, or daily revenue averages, and the industry in which the entity operates. Such verification is possible when the aggregated transaction data contains detailed information for the various transactions, though it should be apparent that the entity's pulse can be obtained even from transaction data that only identifies sellers or buyers to a transaction. The verified information for different entities can then be culled to generate holistic reports identifying entities selling similar goods and services (i.e., competitors), operating in a common geographic region, or that use similar vendors or suppliers. The verified information can then be entered into a database that stores verified information about different entities. Additionally or alternatively, the verified information can be used to verify information that a database stores on various entities.

In some embodiments, the pulse or verified entity status is leveraged for various extended applications. One such extended application is to use the pulse to validate various directories, such as those provided by Yellow Pages, White Pages, and Yelp as some examples. In some embodiments, validating a directory involves removing entries for entities that have been determined to not have a pulse while retaining entries for entities that do have a pulse and are thus determined to be active and operational. Another extended application is to use the pulse to validate results of on-demand services, such as results of online search providers. Here again, validation involves removing from the search results, entries to entities that have been determined to not have a pulse while retaining as part of the search results, entries to entities that have a pulse. Another extended application is to use the pulse to scrub marketing lists. In some embodiments, scrubbing a marketing list involves removing listings for entities that have been determined to not have a pulse while retaining listings for entities that have a pulse. This application can save time and money by preventing the solicitation of entities that are no longer operational but are nevertheless included in the outdated marketing list.

In some embodiments, the transaction driven verification and credibility system leverages the transaction data to derive an accurate and real-time measure of entity credibility. The system can derive entity credibility from a historical analysis or comparative analysis of the transaction data or some combination thereof.

When deriving credibility from a historical analysis, the system isolates the transaction data for a particular entity from the aggregated transaction data. The system then analyzes that particular entity's transaction data for fluctuations and trends. One manner of deriving the entity's credibility is to monitor for increases or decreases in the number of transactions executed by that particular entity, wherein increased transaction volume is objective indicia that more clients are entrusting that particular entity for its goods and services and that the particular entity's reputation is growing amongst its potential client base. Alternatively or additionally, the system can derive entity credibility by monitoring for increases or decreases to the average transaction price or for increases or decreases in pricing of specific goods and services.

When deriving credibility from a comparative analysis, the system gauges an entity's credibility based on how that entity's transactions compare to those of its competitors. Accordingly, the system identifies the entity's competitors. The competitors are other entities that have similar characteristics as the entity whose credibility is being determined. The similar characteristics can relate to industry, geographic region, size, years in operation, and offered goods and services, as some examples. The system can automatically identify the primary competitors based on the goods and services that appear in the entity's transaction stream as well as the quantity of such transactions as one example. In some such cases, the competitors are identified by analyzing the aggregated transaction data to identify other entities that sell similar goods and services at or near a similar volume of transactions as the particular entity. Next, the system computes the particular entity's credibility based on how the particular entity's volume of transactions, average transaction price, or price for specific goods and services compare to those of its competitors. The system increases the credibility of the particular entity when the transaction data reveals the particular entity outperforming its competitors and decreases the credibility of the particular entity when it underperforms relative to its competitors. Over time, the systems and methods adjust the entity's credibility according to how its transaction data fluctuates relative to the transaction data for its competitors.

In this manner, the system computes entity credibility using objective indicia of credibility. Specifically, each of transaction volume, average transaction price, and pricing of specific goods and services indirectly attest to credibility factors that induce clientele to prefer the entity over its competitors, such as the entity's customer service, trustworthiness, timeliness, quality, responsiveness, cleanliness, and return policy.

In some embodiments, the system leverages the transaction data to provide suggestions for improving credibility. To do so, the system monitors an entity's transaction stream as well as the transaction streams of its competitors. The system then identifies which goods and services the competitors are effectively selling and that the entity should promote or emphasize. Additionally, from the transaction streams, the system can offer an entity competitive insight with regards to how its competitors are pricing their goods and services.

### BRIEF DESCRIPTION OF THE DRAWINGS

In order to achieve a better understanding of the nature of the present invention a preferred embodiment of the transaction driven verification and credibility system will now be described, by way of example only, with reference to the accompanying drawings in which:

FIG. 1 presents a process with which the system derives a pulse for a particular entity in accordance with some embodiments.

FIG. 2 presents a process for generating a real-time directory of active and operational entities in accordance with some embodiments.

FIG. 3 presents conceptually differing methodologies for using the pulse to validate a directory in accordance with some embodiments.

FIG. 4 illustrates a first interface displaying a first set of search results that have not been verified to have a pulse, a second interface displaying a subset of the first set of search results that have been verified to have a pulse, and a third interface displaying the first set of search results with visual identifiers to differentiate those entities that have been verified to have a pulse in accordance with some embodiments.

FIG. 5 presents a process for using an entity's pulse to validate a marketing list in accordance with some embodiments.

FIG. 6 presents a process for computing credibility of a particular entity using transaction data in accordance with some embodiments.

FIG. 7 conceptually illustrates objectively deriving and adjusting a credibility score using transaction data in accordance with some embodiments.

FIG. 8 presents a process for deriving entity credibility using the comparative analytic methodology of some embodiments.

FIG. 9 conceptually illustrates that transaction processing system of some embodiments.

FIG. 10 illustrates a computer system with which some embodiments are implemented.

### DETAILED DESCRIPTION OF THE INVENTION

In the following detailed description, numerous details, examples, and embodiments of various systems and methods are set forth and described. As one skilled in the art would understand in light of the present description, the system and methods are not limited to the embodiments set forth, and the system and methods may be practiced without some of the specific details and examples discussed. Also, reference is made to accompanying figures, which illustrate specific embodiments in which the invention can be practiced. It is to be understood that other embodiments can be used and structural changes can be made without departing from the scope of the embodiments herein described.

Some embodiments set forth a transaction driven verification and credibility system that verifies entity status and derives entity credibility from transaction data. Various terminology is defined to aid in the disclosure of the transaction driven verification and credibility system.

The term entity is used to refer to either a merchant or client. A merchant is an individual or business that engages in the sale of one or more items. The items being sold can be any good or service. A client is an individual or business that purchases or consumes an item that is sold by a merchant. An entity database is a database that stores identifying information about different business and individual entities. Some such databases are maintained by credit reporting agencies, data aggregators, and directories as some examples.

Transaction data refers to information about a transaction completed between two entities. A completed transaction involves the sale of one or more goods or services from a merchant to a client. The information about the transaction can identify the client making the purchase, the merchant making the sale, itemization of the one or more items sold, the sale price, and an identifier identifying the location at which the transaction occurs as some examples. Depending on the source from which the transaction data is obtained, some of this information may be anonymized or omitted. Nevertheless, most or all of this information is captured in credit card transactions by credit card processors or banks. Specifically, in order to accept credit card payments, the merchant registers itself or a Point-Of-Sale (POS) terminal with the credit card processor or bank, such that whenever the merchant conducts a credit card transaction, the credit card processor or bank captures the merchant or POS terminal where the transaction is made, the price of the transaction, a time and date, and possibly a description for the transaction. In preferred embodiments, transaction data refers to credit card transaction data that can be aggregated or obtained from one or more credit card processors, banks, or third-parties aggregators that collect the credit card transaction data from various sources and offer access to the aggregated credit card transaction data. In some cases, the system of some embodiments gains access to the transaction data by operating directly with transaction processors and aggregators, establishing partnerships with the transaction processors or aggregators, or paying a fee to access the transaction data. It should be apparent that the transaction data can also include information obtained from transactions that are conducted using wire transfers, digital payment, and other forms of payment.

Generally, credibility refers to how an entity is perceived by its peers. A particular entity's credibility is determined primarily based on experiences that others have with that particular entity. A disproportionate number of positive experiences translates into good credibility with a disproportionate number of negative experiences transiting into poor credibility. Entities look to credibility when deciding whether or not to transact with another. Specifically, entity credibility provides a measure of what kind of experience an entity should expect from another. The factors from which credibility is derived vary based on which factors different entities consider important. Some of the more significant credibility factors include trustworthiness, reputation, timeliness, quality, responsiveness, cleanliness, friendliness, and/or stability. These factors can manifest in qualitative data, such as sentiment that is expressed in posts, reviews, and critiques, as well as quantitative data, such as rankings and ratings. However, the inventors have identified direct correlations to also exist between transaction data and credibility, wherein the transaction data provides an objective measure of credibility. For instance, a credible business is one that is likely to have a higher volume of transaction data, average price per transaction, or price per specific goods and services than a business that is not credible. Based on this observation, it is possible to compute entity credibility objectively using transaction data.

I. Verification

In some embodiments, the system derives a “pulse” for each of several different entities based on entity transaction data. This pulse is an ongoing and real-time verification for the operational status of each entity. The direct application of the pulse or verified entity status is to inform others about the operational status of a desired entity. Other direct applications involve verifying information about an entity including, for example, a geographic region or address from which the entity operates, size of the entity, annual, monthly, or daily revenue averages, and the industry in which the entity operates. The verified information can also be used in generating holistic reports identifying entities selling similar goods and services (i.e., competitors), operating in a common geographic region, or that use similar vendors or suppliers. The verified information can be entered into a database or used in verifying previous information stored to the database. In some embodiments, the pulse or verified entity status is leveraged for various extended applications. One such extended application is to use the pulse to generate a directory of active and operational entities. Another extended application is to use the pulse to validate existing lists and directories, wherein the pulse is used to scrub the lists and directories of obsolete or inaccurate data. Another extended application is to use the pulse to validate results of on-demand services, such as results of online search providers.

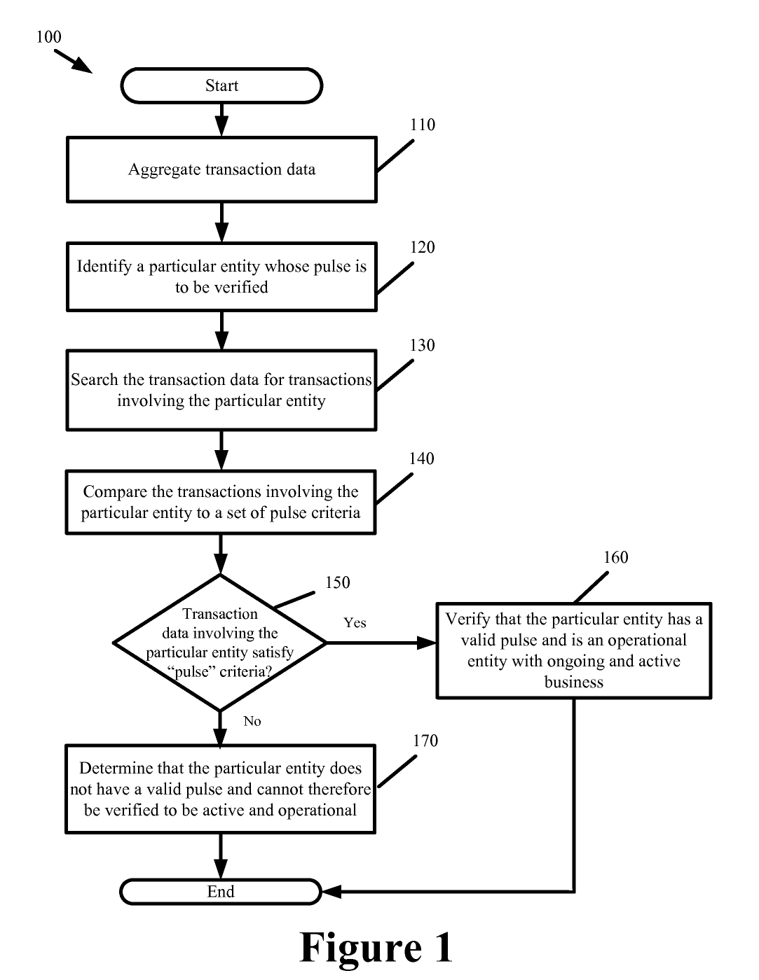

FIG. 1 presents a process 100 with which the system derives a pulse for a particular entity in accordance with some embodiments. The process 100 commences by the system aggregating (at 110) transaction data. The process may aggregate the transaction data from one or more sources. For example, the process may aggregate transaction data from each of several credit card transaction processors or banks. As part of the aggregating step, the system stores some prior interval of transaction data. In some embodiments, the system aggregates the transaction data on a continual basis. In some such embodiments, the system aggregates the transaction data as it is processed by a transaction processor. In some embodiments, the system aggregates the transaction data on a periodic repeating basis (e.g., every ten minutes, every hour, every day, etc.). The system may aggregate the transaction data directly from various transaction processors or banks. Alternatively, the system may aggregate the transaction data from a third-party aggregator that has established relationships with various transaction processors or banks and that offers access to the transaction data from each of these sources. The aggregation may occur over network interfaces in which IP/TCP messaging protocols or other secure transfer protocols are used to transfer the transaction data, wherein the transfer may be initiated using any of a push or pull mechanism. The transaction data can also be encrypted during transmission.

Next, the process identifies (at 120) a particular entity whose pulse is to be verified. The process may systematically determine the pulse of each of a plurality of entities monitored by the system. Alternatively, the process may identify the particular entity based on a request from a user. The particular entity is identified with an identifier. The identifier may include a name, address, email, telephone number, merchant identifier, unique identifying code, or some combination thereof, wherein the merchant identifier is a code that a transaction processor uses to identify a selling entity or merchant. In some embodiments, the system maps the merchant identifier to a corresponding name, address, telephone number, or other identifying information for the entity. In some embodiments, the identifier is used to query an entity database in order to extract additional identifying information about the particular entity. For example, once the entity name is provided to the entity database, a record for that entity is retrieved and additional identifying information such as a street address, telephone number, etc. are extracted from the record. In some embodiments, the identifier may specify an entity name that matches to multiple different entities within the entity database. In such cases, additional identifiers are required to uniquely select one of the matching entities. The process can extract the additional identifying information once a unique matching entity is identified.

The process searches (at 130) the aggregated transaction data for transactions that involve the particular entity. In some embodiments, the search may restrict the results to transaction data in which the particular entity is the seller/merchant, buyer/client, or both. Transactions involving the particular entity are identified using the particular entity's identifying information. In some embodiments, a mapping operation is performed to convert the identifying information to proprietary identifiers that a transaction processor uses to identify different entities. For example, the entity with the name ACME Corp. may be identified in transaction data from a first transaction data source using a first identifier, 9327521, and may be identified in transaction data from a second transaction data source using a second different identifier, ACME_{—}90265. In any case, the process uses the proper identifier to identify the transactions that involve the particular entity. As a result of the search, the process obtains a subset of zero or more transactions that involve the particular entity.

The process then compares (at 140) the transactions involving the particular entity to a set of pulse criteria. The pulse criteria define a threshold for determining if the particular entity has a “pulse”. In other words, the pulse criteria define a threshold for determining whether the particular entity is active or inactive. The pulse criteria may be specified as a minimum transaction volume within a given time interval or average price per transaction within the given time frame, or some combination thereof. Other transactional aspects of the transaction data may be used in specifying the pulse criteria. The pulse criteria can be as simple as identifying one transaction per work week day in which the particular entity is the seller or merchant. In some embodiments, the pulse criteria differ for different entities. The different pulse criteria can be used to modify the verification threshold for different entities based on their respective industry, geographic region, size, revenue, years in operation, etc. For example, the process may verify a large entity when the process can identify a minimum of $1,000/day in transactions for that large entity and the process may verify a small entity when the process can identify a minimum of $100/day in transactions for that small entity.

Should the transaction data involving the particular entity satisfy (at 150) the pulse criteria, the process verifies (at 160) that the particular entity has a valid pulse and is an operational entity with an ongoing and active business. Otherwise, the process determines (at 170) that the particular entity does not have a valid pulse and cannot therefore be verified to be active and operational (i.e., have an ongoing business).

Process 100 can be run periodically for several entities to ensure that the verification status of those entities is continually updated. For instance, process 100 can be run daily using the current or previous day's transaction data in order to provide a real-time pulse. Process 100 can also be an ongoing process that executes whenever new transaction data is aggregated. In some embodiments, the system has a database to store the verification status of each entity. In some embodiments, the database stores the verification system of each entity at different time intervals. For instance, at the end of each day, the system may store the verification status for an entity.

Some embodiments provide more granular verification by verifying individual locations that are operated by an entity. Such granular verification is beneficial for a business entity that has multiple locations. In such cases, it is important to not only know that the business as-a-whole is active and operational, but which locations operated by that business entity are active and operational.

To verify individual locations, the system extracts not only a merchant identifier identifying the entity, but also a PoS identifier from the transaction data. As described above, the PoS identifier identifies the specific terminal at which a transaction is conducted. These terminals are typically mapped to a geographic region or, more specifically, to a particular location. The mapping information can be obtained from the transaction processor or directly from the PoS identifier itself when the PoS identifier is encoded with geo-coordinates or other location information. Accordingly, by determining a pulse for a PoS identifier, the system is able to not only verify a pulse for an entity, but also a location at which the entity operates.

In some embodiments, the system uses the transaction data to verify information about the entity in addition to verifying the entity itself. When the transaction data details the amount of each transaction, the system can track the amounts of goods or services sold by a particular entity over time in order to determine the revenue that is generated by that particular entity. This value can then be entered to the entity database or used to validate a previous revenue entry for the particular entity to the entity database. From the amount of each transaction, the number of transactions, or the number of verified locations, the system can also verify the size of a particular entity. When the transaction data describes the goods or services involves with one or more of the particular entity's transactions, the system can verify the industry in which the particular entity operates. These are examples of some of the verifications that the system of some embodiments can objectively perform using only the aggregated transaction data.

From this verified information, the system can generate holistic reports such that verified information on an entity need not be viewed in isolation, but can be provided from a comparative perspective. For instance, when the system verifies the geographic region and industry in which each entity operates, the system can generate a report identifying the regional competitors of an entity. Similarly, when the transaction data describes the goods or services sold by various entities, the system can leverage this information to identify competitors for a given entity on the basis of similar goods and services being sold.

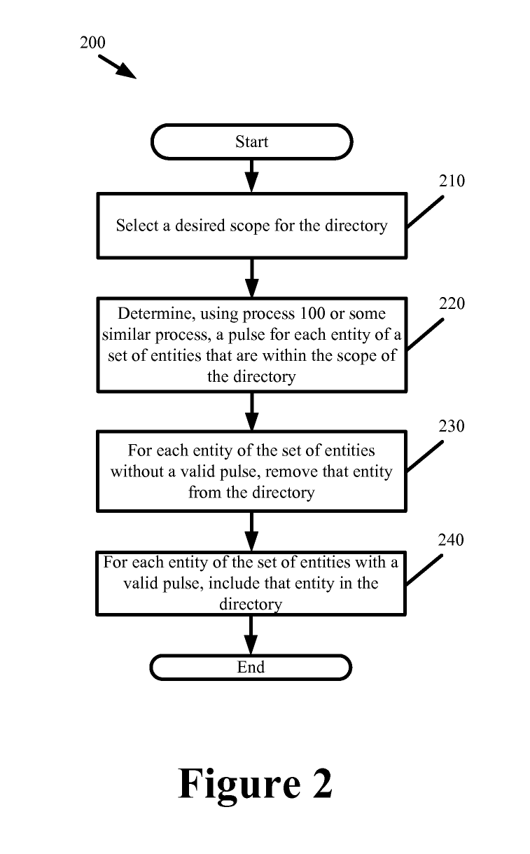

The process 100 can be extended in some embodiments to generate a real-time directory of active and operational entities. FIG. 2 presents a process 200 for generating a real-time directory of active and operational entities in accordance with some embodiments. The process 200 commences by selecting (at 210) a desired scope for the directory. The desired scope is selected based on criteria identifying a set of entities that are to be verified. For example, the criteria can limit the directory to cover entities with geographic commonality (e.g., entities in the 90265 zip code), industry commonality (e.g., entities that operate as restaurants), or revenue or income commonality. The set of entities can be selected based on any combination of the above enumerated commonalities or other commonalities not explicitly enumerated herein. To identify the set of entities, the system may query a secondary database, such as the earlier described entity database, that provides the additional identifying information for determining whether an entity satisfies the qualification criteria.

The pulse of each entity in the set of entities is then determined (at 220) according to process 100 or some similar process. If a particular entity in the set of entities is determined to not have a pulse by failing to satisfy the pulse criteria, that particular entity is removed (at 230) from the directory if previously present therein. If a particular entity in the set of entities is determined to have a pulse by satisfying the pulse criteria, that particular entity is included (at 240) in the directory or its status is updated if previously present therein. An entity that is not previously in the directory and that is newly added can be indicative of a newly formed business or a new business branch as some examples. To add a particular entity to the directory, the process obtains identifying information for the particular entity. This information can be obtained from the transaction data itself or through the transaction processor, bank, or third party from which the transaction data is aggregated. Alternatively, the identifying information can be sourced from other sources such as the particular entity's website, entity database, governmental agency, etc. The directory can then be sold to others. Access to the directory can be provided through an application programming interface (API) or network interface. In some embodiments, the directory is the building block for constructing a review site or marketing list.

In the above described manner, the system can keep a current status for each of several entities. The system may also store the transaction data that is identified for the entity in conjunction with the entity's status as well as the information that is verified therefrom (e.g., revenue, size, industry, etc.). Through various push or pull interfaces and application programming interfaces (APIs), the status, transaction data, and verified information for each entity can be provided for various extended applications that require ongoing or real-time verification of an entity's operational status. One such application of the pulse verification data is to scrub or validate directories or listings administered by various third parties.

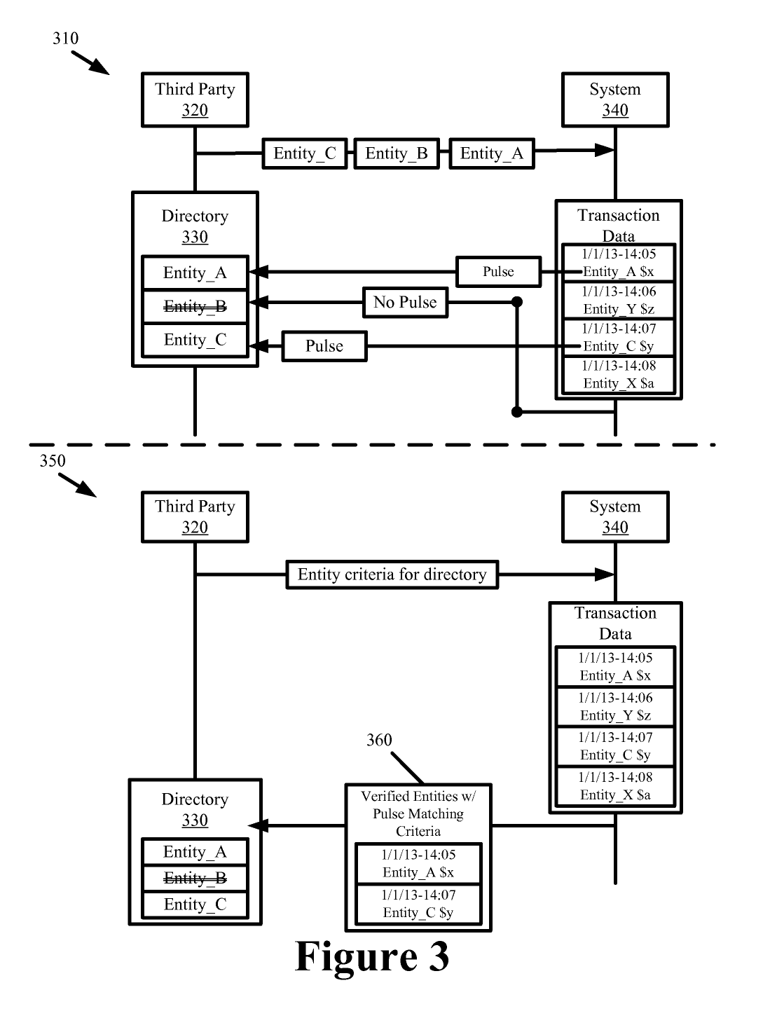

FIG. 3 presents conceptually differing methodologies for using the pulse to validate a directory in accordance with some embodiments. The directory can be any listing of entities. A general directory, such as the Yellow Pages, can provide comprehensive regional business listings. More specific directories, such as Zagat or OpenTable.com, can provide restaurant specific listings for example. In any case, it is essential that these directories provide up-to-date and accurate information as to the status of each entity in their directory.

Each listed entity in the directory can be validated in at least one of two ways. First, the system of some embodiments can perform an entity-by-entity verification. In this case illustrated by scenario 310, a third party 320 administers a directory 330 that is validated using the system 340 and methodologies of some embodiments. In scenario 310, the third party 320 inputs one or more identifiers identifying entities from the directory 330 to the system 340. The identifiers can be entity names, addresses, or identifiers used by transaction processors to identify the entity as some embodiments. In some embodiments, the system 340 maps the identifiers provided by the third party 320 to identifiers that are used by the transaction processors to identify the entities.

The system 340 then determines a pulse for each entity by first determining whether any of the transaction data involves that entity and then determining if the transaction data involving the entity satisfies the pulse criteria. It should be noted that in some embodiments, this step can be substituted with a lookup of the entity identifiers against the entity database when the entity database already stores the verified status for the identified entities. The system 340 then provides the third party 320 verification status for each identified entity, wherein the verification status includes either a pulse that is indicative that the entity is active and operational or no pulse that is indicative that the entity cannot be verified to be active and operational. This provides a real-time and on-demand validation of the directory 330.

In the alternative scenario depicted in 350, the third party 320 sends criteria for the entities that are included in the directory 330. The criteria can limit the entities based on geographic region, industry, revenue/income, age, etc. The criteria are intended to focus the list of verified entities with a pulse that are returned by the system 340. Upon receiving the criteria, the system 340 scans the aggregated transaction data to identify which entities satisfy both the third party 320 submitted criteria and the pulse criteria. The system 340 then issues a list of entities 360 that satisfy both sets of criteria with each entity in the list 360 having been verified as active and operational (i.e., having a pulse). The third party 320 then validates its own directory 330 against the provided list of entities 360.

In these manners, any directory or listing can be scrubbed to remove or disable information relating to a non-operational or inactive entity. Examples of some directories that can leverage this service include Yelp, City Search, the Better Business Bureau, Secretary of State, Internal Revenue Service, and regional Chambers of Commerce.

The system can also be used to screen search results prior to presenting the search results to a user. For example, a search engine can provide a search interface whereby users can search for entities that meet user specified search parameters. The search engine can execute the search and produce a result set with a first set of entities that meet the search parameters. Before presenting the result set to the user, the search engine may screen the result set using the system of some embodiments. The system identifies which entities in the first set of entities have a pulse and which do not. The search engine then produces a modified result set with a second set of entities that includes the entities from the first set of entities that are verified by the system of some embodiments as having a pulse (i.e., being operational) while excluding those entities from the first set of entities that cannot be verified by the system of some embodiments as having a pulse. Alternatively, the system may identify for the search engine which of the first set of entities has a pulse. The search engine can then depict the first set of entities with some visual differentiator for those entities that are verified as a having a pulse.

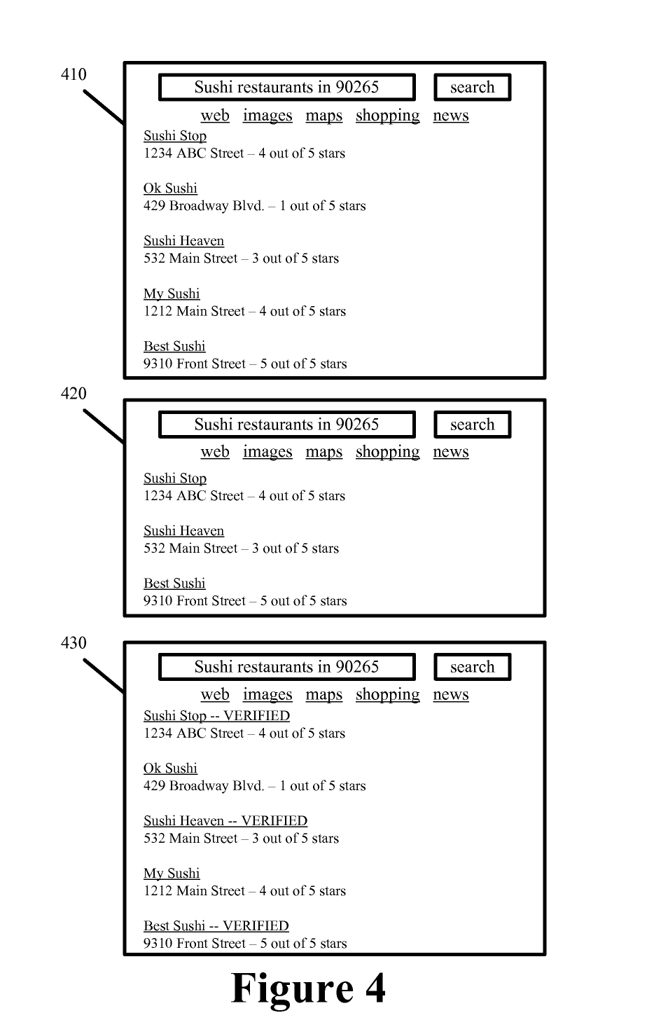

FIG. 4 illustrates a first interface 410 displaying a first set of search results that have not been verified to have a pulse, a second interface 420 displaying a subset of the first set of search results that have been verified to have a pulse, and a third interface 430 displaying the first set of search results with visual identifiers to differentiate those entities that have been verified to have a pulse in accordance with some embodiments.

Yet another application of a verified entity's pulse is to validate marketing lists. A marketing list is a listing of entities that one can market various goods and services to. Marketing lists are often customized for a specific need. For example, one marketing list can identify all automobile dealerships in a given region and a second marketing list can identify retailers having annual revenues exceeding a specified amount. In some cases, one or more listed entities within a marketing list are irrelevant because the entity has gone out of business, relocated, or otherwise become unreachable. The marketer acquiring the marketing list will lose time and money unnecessarily trying to contact or send marketing materials to these unreachable entities. Accordingly, a significant time and cost savings can be realized by scrubbing these marketing lists to include only entities that have been verified using the transaction data to have an active and operational pulse.

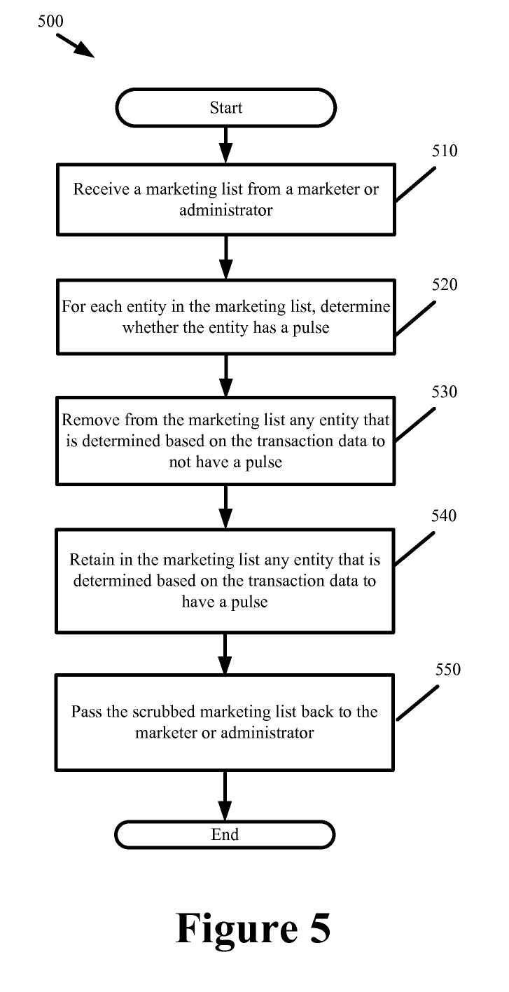

FIG. 5 presents a process 500 for using an entity's pulse to validate a marketing list in accordance with some embodiments. The process 500 commences by receiving (at 510) one such marketing list. The marketing list may be provided by a marketer that purchased the marketing list or by an administrator that constructs the marketing list. The marketing list is typically comprised of entity identifiers and contact information. The entity identifiers usually provide the name of the entity or one or more agents of the entity. The contact information usually provides a telephone number, email address, or mailing address.

For each entity in the marketing list, the process determines (at 520) whether that entity has a pulse. To do so, the system scans the aggregated transaction data to identify the transactions that each entity was involved in over a given time interval. Then, the process determines if those transactions for a given entity are sufficient to satisfy pulse criteria.

Any entity that cannot be verified using the transaction data to have a pulse is scrubbed or removed (at 530) from the marketing list. Any entity that is determined based on the transaction data to be active and operational, and therefore have a pulse is retained (at 540) in the marketing list.

The scrubbed marketing list is then passed (at 550) to the marketer or administrator. Marketers can then safely market to all entities in the marketing list knowing that the included entities are currently active and operational. Marketing lists using email addresses, telephone numbers, or other contact information can be scrubbed in this fashion.

This methodology is also applicable for scrubbing unused profiles, accounts, or email accounts/addresses offered by various online service providers. Service providers, such as Facebook and Twitter, allow any entity, including a business entity, to create an account. However, these service providers have no real-time means with which to determine when the entity associated with an account becomes inoperable or goes out of business such that the account can be deleted or disabled. The service provider can monitor the account for a period of inactivity, but there is a significant lag associated with this method. To avoid this lag and monitoring on the part of the service provider, the system of some embodiments can notify the service provider when an entity has become non-operational due to a stop in transaction activity for that entity. Once notified, the service provider can then remove the account that is associated with the non-operational entity.

Each of the above enumerated applications provides a real-time and efficient means with which to keep a directory or list up-to-date. These applications increase the accuracy and value of the directory. The verification function provided by the system of some embodiments, thus resolves a significant issue confronting many service providers that operate a directory or list and have no efficient and accurate way to identify which entities listed within the directory or list are active and operational and which ones are not.

In some embodiments, the pulse is used to verify that one entity is an agent or representative of another. This scenario is particularly useful in verifying that an entity is an employee of a business. To perform this verification, the agent notifies the system of a transaction that it will conduct on behalf of the entity as well as provide the system with identifying information. Should the transaction appear in the aggregated transaction data as specified by the agent, the system verifies the agent as representative of the entity.

II. Credibility

When deciding whether or not to engage with a business entity, an individual is less concerned with the credit of that business entity than with the credibility of that business entity. Credibility conveys the experiences that others have had with the business entity. Credibility is comprehensive in that accounts for factors such as pricing, quality, friendliness, reliability, trustworthiness, timeliness, cleanliness, etc., whereas credit is almost exclusively tied to financial risk. Various combinations of these and other credibility factors are quantified into different credibility scores.

The credibility score is normally a numerical value, though other representations of the score are also applicable in some embodiments. The prior art derives the credibility score from subjective credibility data. Some examples of subjective credibility data include reviews and ratings that entities post online. Each such review or rating embodies sentiment relating to an experience that one entity had with another entity that is the target of the review or rating.

Some embodiments set forth a new methodology with which to objectively derive a credibility score. In some such embodiments, the system objectively derives an accurate and real-time measure of entity credibility from that entity's transaction data. The system can derive entity credibility from a historical analysis or comparative analysis of the transaction data or some combination thereof.

A. Historical Analysis

Generally, credibility is a reflection of how positively or negatively others view an entity. This sentiment is quantified to a credibility score and the credibility score is then used to determine whether or not to engage with that entity. The embodiments described herein take an inverse approach, whereby transaction data is used to measure the credibility of an entity, and thereby gauge the sentiment regarding the entity.

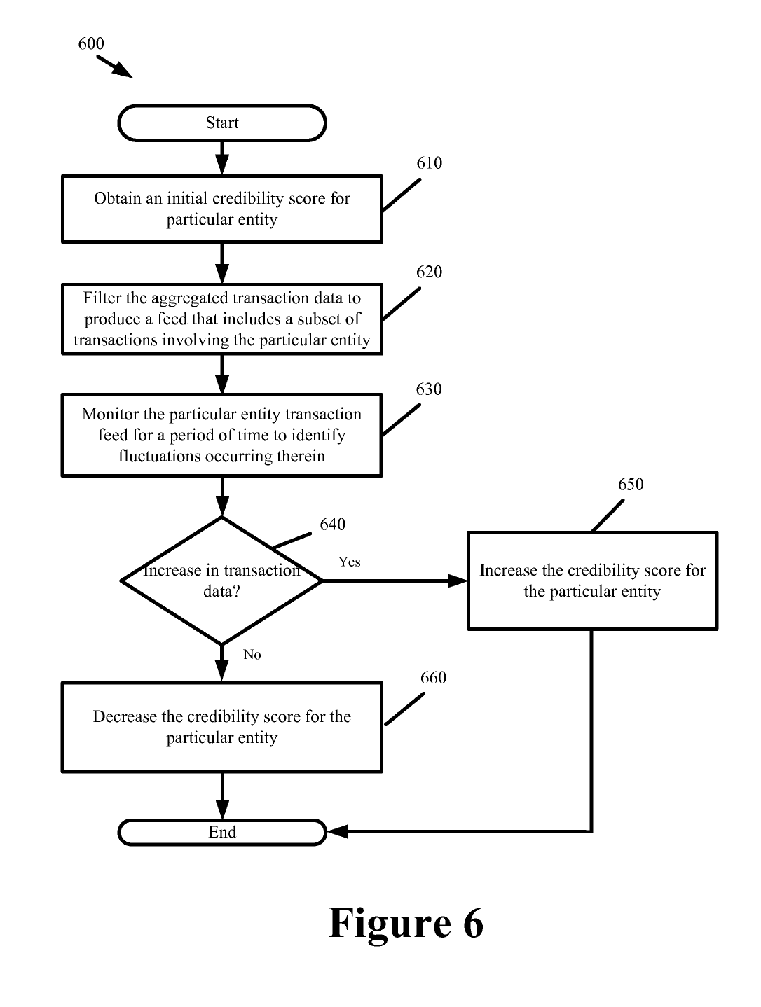

FIG. 6 presents a process 600 for computing credibility of a particular entity using transaction data in accordance with some embodiments. The process begins by obtaining (at 610) an initial credibility score for a particular entity. The initial credibility score can be computed from aggregated qualitative and quantitative credibility data such as user reviews, ratings, and the like. Alternatively, the initial credibility score can be computed from an initial set of transaction data to which the particular entity is a party and from basic identifying information about the particular entity. Some basic identifying information includes the geographic region and industry in which the particular entity operates, the number of years the particular entity has been in operation, and size of the particular entity. From this identifying information, the system will estimate a volume and transaction amount for the particular entity. If the initial set of transaction data exceeds the system's estimates and depending on the degree with which the particular entity exceeds the estimates, the system provides the particular entity with an above average initial credibility score. If the initial set of transaction data falls short of the system's estimates and depending on the degree with which the particular entity falls short of the estimates, the system provides the particular entity with a below average initial credibility score.

Next, the process filters (at 620) the aggregated transaction data. In so doing, the system produces a feed that includes a subset of transactions to which the particular entity is a transactional party. The process then monitors (at 630) the particular entity transaction feed for a period of time to identify fluctuations occurring therein. The monitoring can be ongoing or for some fixed duration (e.g., three months). The process identifies (at 640) increases or decreases in transaction data, wherein an increase or decrease can include either an increase or decrease in the volume of transactions that are transacted by the particular entity, an increase or decrease in average price per transaction, or an increase or decrease in price of goods and services.

To identify an increase in transaction volume, the system monitors the particular entity transaction data feed and, for one or more specified intervals, records the transaction volume transacted (i.e., number of executed transactions) in that interval. The intervals can be on the order of minutes, hours, days, weeks, or months. Comparisons are then made over equivalent intervals to determine if there was an increase or decrease in transaction volume. For example, the system can identify an increase in transaction volume when the particular entity averages 50 transactions a day for a first month and averages 55 transactions a day for a second month. Similarly, the system can identify an increase in transaction volume when the particular entity averages 50 transaction a day for a particular month in a first year and average 55 transactions a day for the same particular month in a second year.

To identify an increase in average price per transaction, the system monitors the particular entity transaction data feed and records the average amount transacted per transaction for specific intervals. Comparisons are then made between equivalent intervals to see if the average amount per transaction has increased or decreased from one equivalent interval to another. In order to perform this analysis, the aggregated transaction data should at least include an aggregate price for each transaction irrespective of how many or which goods and services were involved with each transaction. For example, the system can identify an increase in the average amount per transaction when the average price of a transaction executed by the particular entity is $100 during a first month and the average price of a transaction executed by the particular entity is $115 during a second month.

To identify an increase in price of goods of services, the system monitors the particular entity transaction data feed to identify the sale of a common good or service occurring in at least two different intervals. The system then compares the later occurring transaction with the earlier occurring transaction to see if the price of the good or service increased, decreased, or remained the same. In order to perform this analysis, the aggregated transaction data should include a short description for the goods or services that were sold.

Each such increase is objective indicia that more clients are gravitating towards the particular entity for its goods or services and that the particular entity's reputation is growing amongst its client base. Accordingly, the process increases (at 650) the credibility score for the particular entity when an increase in transaction data is identified at 640. Each such decrease is objective indicia that less clients are gravitating away from the particular entity for its goods or services and that the particular entity's reputation is in decline amongst its client base. Accordingly, the process decreases (at 660) the credibility score for the particular entity when a decrease in transaction data is identified at 640.

In some embodiments, the increase or decrease in the credibility score is proportional to the identified increase or decrease in the transaction data. However, it should be noted that the adjustment to the credibility score can be based on more than one perceived change in the transaction data and that a first change (e.g., change in transaction volume) can be weighted more heavily than a second change (e.g., change in average transaction price) such that the first change has a greater impact on the credibility score than the second change.

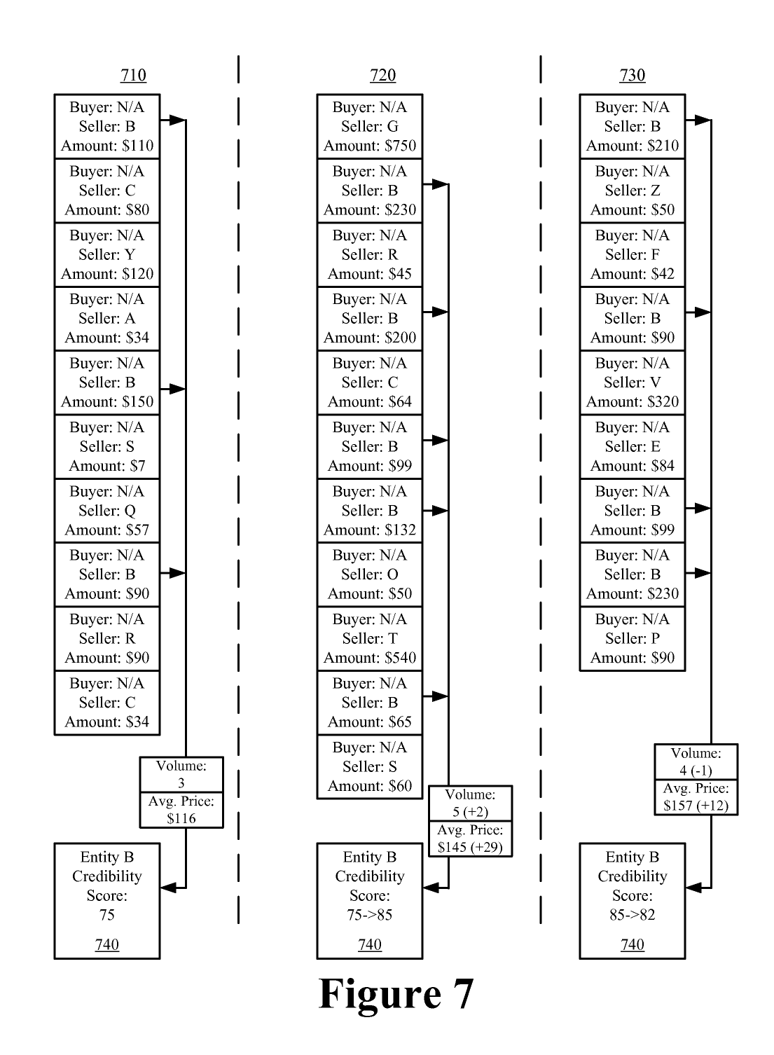

FIG. 7 conceptually illustrates objectively deriving and adjusting a credibility score using transaction data in accordance with some embodiments. FIG. 7 illustrates a transaction feed at three different intervals 710, 720, and 730 and how the transaction data from the feed impacts a credibility score 740 of a particular entity at each of the intervals 710, 720, and 730. Specifically, the figure illustrates how the credibility score 740 is adjusted based on the particular entity's volume of transactions and average transaction price at each of the intervals 710, 720, and 730. As shown, the transaction feed anonymizes the buyer information, but identifies the seller and the amount of each transaction. Such a transaction feed is suitable for use in computing and adjusting the credibility score of the particular entity in accordance with some embodiments.

At 710, an initial value for the credibility score 740 is computed based on three transactions and an average transaction price of $116 that are identified from the feed as having been executed by the particular entity during the first interval. At 720, the credibility score 740 is increased by a first amount based on five transactions and an average transaction price of $145 that are identified from the feed as having been executed by the particular entity during the second interval. From the transaction data, the system identifies an increase in transaction volume and an increase in average transaction price for the particular entity. These increases are objective indicia that the business and financial prospects of the particular entity are improving from the first interval 710 to the second interval 720. These improvements also indicate that the particular entity's credibility is improving among its client base which is reflected by the first amount increase of the credibility score.

From the second interval 720 to the third interval 730, the particular entity's transaction volume decreases from five to four. However, the particular entity's average transaction price increases from $145 to $157. Accordingly, the system adjusts the credibility score 740 by a second amount to reflect the change in credibility.

In some embodiments, the system adjusts for seasonal fluctuations, economic fluctuations, and other factors when computing and adjusting the credibility score. To do so, the system identifies the entity for which the credibility score is being derived. First, the system obtains an identifier for the entity. The identifier can be a name, address, or unique identifier with which to identify the entity. The identifier can be obtained as part of a request for the entity's credibility. The identifier can also be obtained from the transaction feed. The identifier is then queried against an entity database to obtain identifying information for the entity. The identifying information then provides the information needed to determine the entity's industry, size, and other relevant factors used in adjusting the credibility score.

In some embodiments, the credibility score for a particular entity can also be adjusted or computed based on the particular entity information that the system verifies from the aggregated transaction data. As was noted above, depending on the amount of information that is available in the aggregated transaction data, the system can verify one or more geographic locations in which the particular entity operates, revenue generated by the particular entity, size of the particular entity, and industry in which the particular entity operates among other verifiable information. This verified information can then be used to compute an initial credibility score for the particular entity. For example, if the revenue of the entity exceeds a threshold for similar sized and aged entities, then the entity can be provided an above average credibility score. Alternatively, the verified information can be compared to information that is collected about the particular entity from various sources. If there is no discrepancy, the credibility of the particular entity can be increased because available information on the particular entity is accurate and relevant.

B. Comparative Analysis

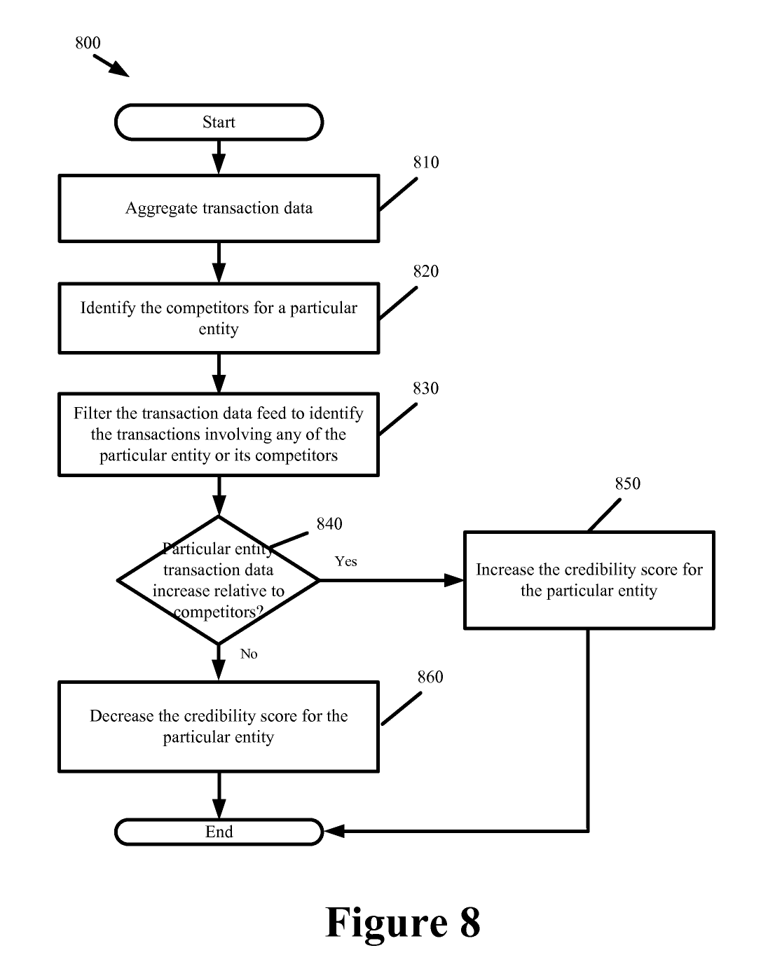

Some embodiments objectively derive entity credibility based on a comparative analysis, whereby the entity's transaction data is compared to the transaction data of its competitors in order to determine whether the entity's credibility has increased or decreased. FIG. 8 presents a process 800 for deriving entity credibility using the comparative analytic methodology of some embodiments.

Process commences 800 by aggregating (at 810) transaction data. The process then identifies (at 820) the competitors for a particular entity, wherein the particular entity is the entity whose credibility is being computed. Competitors are other entities that have similar characteristics as the particular entity. The similar characteristics relate to industry, geographic region, size, years in operation, offered goods and services, of some combination thereof as some examples.

In some embodiments, the process identifies the particular entity's competitors by first obtaining an identifier, such as a name, for the particular entity. Using the identifier, the process can then query an entity database or perform a search to identify the particular entity's competitors.

Alternatively, the process can identify the particular entity's competitors directly from the transaction data. In this scenario, the process monitors the transaction data for the particular entity to identify the volume of transactions conducted by the particular entity, the goods and services associated with the transactions, the average price per transaction, geographic region in which the transactions occur, among other factors. The process then searches the overall aggregate transaction data to identify other entities with transaction data having similar characteristics.

Upon identifying the particular entity's competitors, the process filters (at 830) the transaction data feed to identify the transactions involving any of the particular entity or its competitors. Over one or more intervals, the process compares (at 840) how the particular entity's transaction data fluctuates relative to the transaction data of its competitors. Should the particular entity's transaction data increase relative to the transaction data of its competitors, the process increases (at 850) the credibility score for the particular entity. Conversely, should the particular entity's transaction data decrease relative to the transaction data of its competitors, the process decreases (at 860) the credibility score for the particular entity. Transaction data increases or decreases can be measured in terms of transaction volume, average transaction price, and/or price for specific goods and services.

Additional applications of the transaction data include identifying suggested actions for improving the credibility score. From the transaction data feed, the system has pricing insight as well as insight to specific high-demand goods and services. For an entity that is underperforming relative to its competitors or has a below average credibility score, the system of some embodiments can monitor the transaction data conducted by that entity's competitors and compare the transaction data to the transaction data of the particular entity. From the comparison, the system can automatically identify and suggest pricing modifications or high demand specific goods and services that the entity can sell in order to improve its credibility. Accordingly, the system can generate a report that provides the entity with transactional insight or market opportunities that the entity is unaware of. For example, the report may reveal that an entity's competitor is selling twice the number of a particular good because the competitor is selling that good at a ten percent lower price based on descriptions and pricing of the goods and services that appear in the transaction data. Alternatively, the report may reveal that an entity's competitor is selling a high volume of a particular good that the entity has not yet sold based on descriptions of the goods and services that appear in the transaction data.

III. Computer System

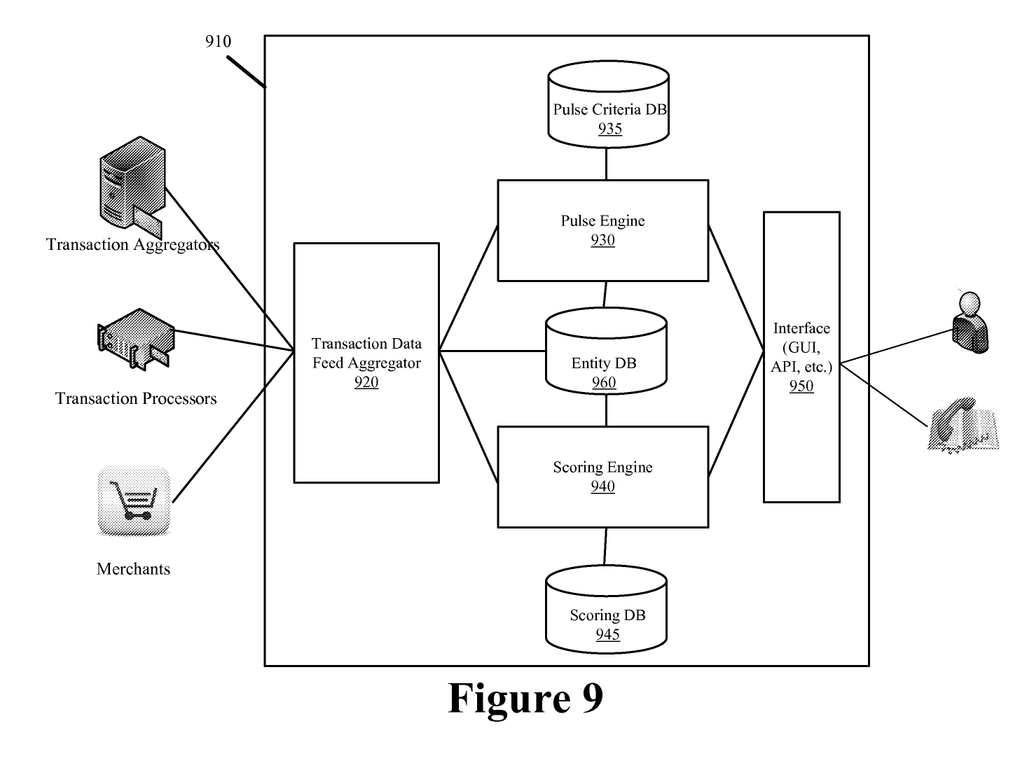

FIG. 9 conceptually illustrates that transaction processing system 910 of some embodiments. The system includes a transaction data feed aggregator 920, pulse engine 930, pulse criteria database 935, scoring engine 940, scoring database 945, and interface 950.

The transaction data feed aggregator 920 obtains the transaction data for the system 910. The transaction data feed aggregator 920 obtains the transaction data by coupling to transaction processors such as credit card processors, other transaction data aggregators, and/or merchants. One transaction data aggregator that compiles transaction data from multiple transaction processors and offers such transaction data is Yodlee, Inc. In some embodiments, the transaction data feed aggregator 920 operates in real-time to collect transaction data as it becomes available from the various sources. In some embodiments, the transaction data feed aggregator 920 collects the transaction data periodically at different intervals. In some embodiments, the transaction data feed aggregator 920 includes a buffer to store some subset of previously aggregated transaction data. Such historic transaction data is needed to determine how one entity's transaction data fluctuates or trends over time.

The pulse engine 930 is the component that scans the transaction data to determine whether different entities have a pulse. The pulse criteria database 935 stores the different criteria by which the pulse determination is made. To identify the proper criteria for an entity, the pulse engine 930 couples to the entity database 960. The entity database 960 can be maintained by the system 910 or by a third party. It is a database that provides identifying information for different entities. For example, an entity can be uniquely identified using any combination of a name, address, telephone number, or email address, and the entity database 960 will return additional information such as the entity's industry, years in operation, revenue, age, etc. The entity database 960 also provides information to the scoring engine 940 and transaction data feed aggregator 920 for the purpose of identifying an entity's competitors and characteristics needed in deriving the credibility score.

The scoring engine 940 is the component that derives a credibility score for an entity based on that entity's transaction data. The scores are stored to the scoring database 945. The scores can be continually derived and updated as new transaction data is aggregated. Alternatively, the scoring engine 940 can function in an on-demand basis, whereby a credibility score for an entity is not computed or updated until a request is made for the credibility score of that entity.

The interface 950 can be any of a graphical user interface, network accessible interface, or application programming interface (API) with which third parties can access the pulse information or credibility score information. The third parties may therefore include directory providers, marketing list providers, and users or service providers interested in the pulse or credibility scores.

Many of the above-described processes and modules are implemented as software processes that are specified as a set of instructions recorded on a non-transitory computer-readable storage medium (also referred to as computer-readable medium). When these instructions are executed by one or more computational element(s) (such as processors or other computational elements like ASICs and FPGAs), they cause the computational element(s) to perform the actions indicated in the instructions, thereby transforming a general purpose computer to a specialized machine implementing the methodologies and systems described above. Computer and computer system are meant in their broadest sense, and can include any electronic device with a processor including cellular telephones, smartphones, portable digital assistants, tablet devices, laptops, desktops, and servers. Examples of computer-readable media include, but are not limited to, CD-ROMs, flash drives, RAM chips, hard drives, EPROMs, etc.

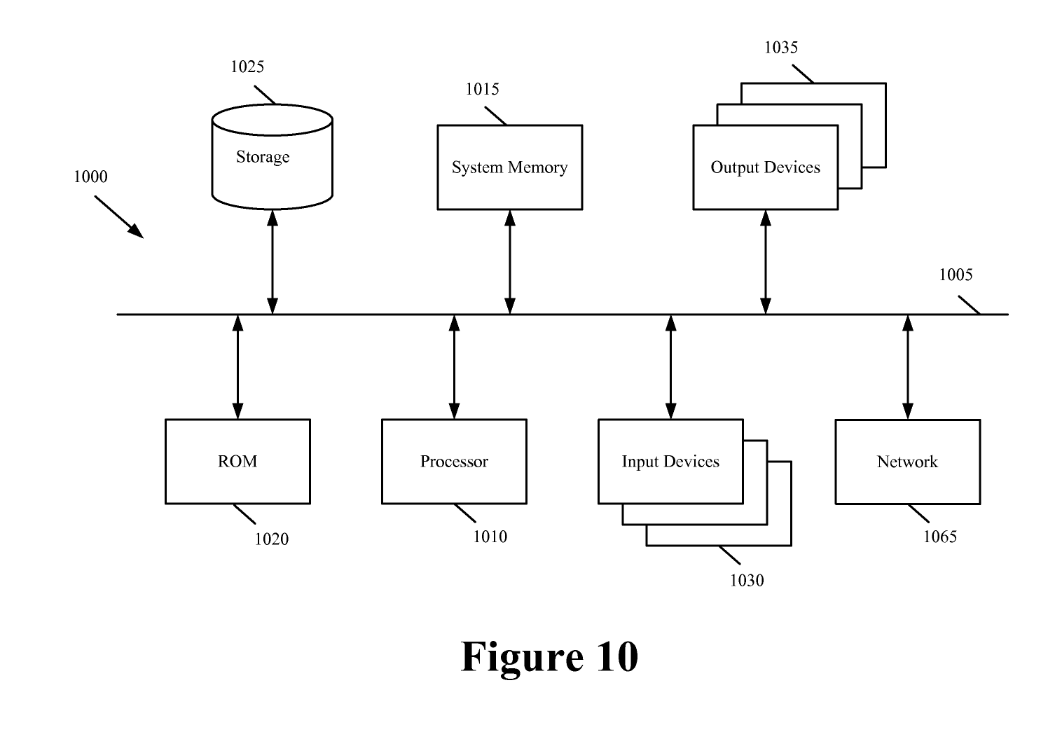

FIG. 10 illustrates a computer system with which some embodiments are implemented. Such a computer system includes various types of computer-readable mediums and interfaces for various other types of computer-readable mediums that implement the various processes, modules, and systems described above. Computer system 1000 includes a bus 1005, a processor 1010, a system memory 1015, a read-only memory 1020, a permanent storage device 1025, input devices 1030, and output devices 1035.

The bus 1005 collectively represents all system, peripheral, and chipset buses that communicatively connect the numerous internal devices of the computer system 1000. For instance, the bus 1005 communicatively connects the processor 1010 with the read-only memory 1020, the system memory 1015, and the permanent storage device 1025. From these various memory units, the processor 1010 retrieves instructions to execute and data to process in order to execute the processes of the invention. The processor 1010 is a processing device such as a central processing unit, integrated circuit, graphical processing unit, etc.

The read-only-memory (ROM) 1020 stores static data and instructions that are needed by the processor 1010 and other modules of the computer system. The permanent storage device 1025, on the other hand, is a read-and-write memory device. This device is a non-volatile memory unit that stores instructions and data even when the computer system 1000 is off. Some embodiments of the invention use a mass-storage device (such as a magnetic or optical disk and its corresponding disk drive) as the permanent storage device 1025.

Other embodiments use a removable storage device (such as a flash drive) as the permanent storage device Like the permanent storage device 1025, the system memory 1015 is a read-and-write memory device. However, unlike the storage device 1025, the system memory is a volatile read-and-write memory, such as random access memory (RAM). The system memory stores some of the instructions and data that the processor needs at runtime. In some embodiments, the processes are stored in the system memory 1015, the permanent storage device 1025, and/or the read-only memory 1020.

The bus 1005 also connects to the input and output devices 1030 and 1035. The input devices enable the user to communicate information and select commands to the computer system. The input devices 1030 include any of a capacitive touchscreen, resistive touchscreen, any other touchscreen technology, a trackpad that is part of the computing system 1000 or attached as a peripheral, a set of touch sensitive buttons or touch sensitive keys that are used to provide inputs to the computing system 1000, or any other touch sensing hardware that detects multiple touches and that is coupled to the computing system 1000 or is attached as a peripheral. The input devices 1030 also include alphanumeric keypads (including physical keyboards and touchscreen keyboards), pointing devices (also called “cursor control devices”). The input devices 1030 also include audio input devices (e.g., microphones, MIDI musical instruments, etc.). The output devices 1035 display images generated by the computer system. The output devices include printers and display devices, such as cathode ray tubes (CRT) or liquid crystal displays (LCD).

Finally, as shown in FIG. 10, bus 1005 also couples computer 1000 to a network 1065 through a network adapter (not shown). In this manner, the computer can be a part of a network of computers such as a local area network (“LAN”), a wide area network (“WAN”), or an Intranet, or a network of networks, such as the internet. For example, the computer 1000 may be coupled to a web server (network 1065) so that a web browser executing on the computer 1000 can interact with the web server as a user interacts with a GUI that operates in the web browser.

As mentioned above, the computer system 1000 may include one or more of a variety of different computer-readable media. Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ZIP® disks, read-only and recordable blu-ray discs, and any other optical or magnetic media.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method for verifying an entity, the method comprising:
with at least one computer having a processor and non-transitory computer-readable storage:
aggregating to the non-transitory computer-readable storage, a plurality of credit card transactions over a specified interval, each transaction from the plurality of credit card transactions comprising an encoded identifier representing one of a business and individual entity involved as one of a buyer and seller to the transaction;
mapping by operation of the processor, the encoded identifier from each transaction of the plurality of credit card transactions to any of a plurality of entities;
identifying by operation of the processor based on said mapping, a subset of the plurality of credit card transactions comprising a common encoded identifier identifying a same particular entity involved as one of a buyer and seller in the subset of transactions;
determining by operation of the processor, operational status of the particular entity from the subset of transactions and pulse criteria, the pulse criteria defining at least one of (i) a minimum number of transactions involving the particular entity in the specified interval and (ii) a minimum aggregate amount totaling from the transactions involving the particular entity in the specified interval; and
outputting a report comprising verification status of the particular entity from the computer to a user, the verification status identifying the particular entity as operational when the subset of transactions in the specified interval exceeds the minimum number of transactions or the minimum aggregate amount defined as part of the pulse criteria.

2. The method of claim 1 further comprising generating the pulse criteria in part from the particular entity's size.

3. The method of claim 1 further comprising scrubbing a listing that provides information about a plurality of entities including the particular entity, wherein scrubbing the listing comprises removing the particular entity from the listing when said outputting identifies the particular entity as being inoperable and retaining the particular entity in the listing when said outputting identifies the particular entity as being operational.

4. The method of claim 1 further comprising entering the particular entity to a database storing a listing of entities that are verified to be operational.

5. The method of claim 1 further comprising, for each entity of a plurality of entities included in a directory, extracting different subsets of transactions from the plurality of credit card transactions that involve the entity as one of a buyer and seller.

6. The method of claim 5 further comprising scrubbing the directory by excluding any entity from the plurality of entities when the subset of transactions involving that entity as one of a buyer and seller does not satisfy the pulse criteria and including any entity from the plurality of entities when the subset of transactions involving that entity as one of a buyer and seller satisfies the pulse criteria.

7. The method of claim 1 further comprising repeating said identifying, determining, and outputting for each of a plurality of entities and generating a directory identifying a subset of the plurality of entities that are verified as being operational.

8. The method of claim 1, wherein each transaction from the plurality of credit card transactions further identifies a transaction amount, and the method further comprising outputting as part of the report, revenue of the particular entity as derived from a total transaction amount computed from each transaction of the subset of transactions.

9. The method of claim 1, wherein each transaction from the plurality of credit card transactions further identifies a good or service, and the method further comprising outputting as part of the report, an industry of the particular entity determined from the goods or services identified in the subset of transactions.

10.-22. (canceled)

23. The method of claim 1, wherein identifying the subset of the plurality of credit card transactions comprises identifying (i) a first subset of transactions completed during a first sub-interval of the specified interval with the particular entity acting as a seller in each transaction and (ii) a second subset of transactions completed during a subsequent second sub-interval of the specified interval with the particular entity acting as the seller in each transaction.

24. The method of claim 23 further comprising obtaining a score representing credibility of the particular entity.

25. The method of claim 24 further comprising adjusting the credibility of the particular entity by increasing the score when at least one of transaction volume and average transaction price from the first subset of transactions is less than that from the second subset of transactions and by decreasing the score when at least one of the transaction volume and average transaction price from the first subset of transactions is more than that computed from the second subset of transactions.

26. The method of claim 1 further comprising identifying a plurality of entities that are to be verified.

27. The method of claim 26 further comprising producing a list of verified entities that includes a first subset of the plurality of entities and excludes a different second subset of the plurality of entities, wherein the first subset of entities comprises at least one entity from the plurality of entities that is identified based on the plurality of credit card transactions as satisfying the pulse criteria, and wherein the second subset of entities comprises at least one entity from the plurality of entities that is identified based on the plurality of credit card transactions as not satisfying the pulse criteria.

28. The method of claim 27 further comprising submitting marketing materials to each entity of the first subset of entities without submitting the marketing materials to any entity of the second subset of entities.

29. The method of claim 27, wherein producing the list of verified entities comprises receiving results of a search engine query that includes the plurality of entities and filtering the results by presenting the first subset of entities and excluding the second subset of entities from the results.

30. The method of claim 27, wherein identifying the plurality of entities comprises any of (i) retrieving the plurality of entities from a third party directory and (ii) retrieving the plurality of entities from a marketing list of a marketer.

31. A non-transitory computer-readable storage medium with an executable program stored thereon, wherein the program instructs a processor to perform sets of instructions for:
aggregating a plurality of transactions over a specified interval, the plurality of transactions identifying a plurality of individual or business entities as any of buyers and sellers to the plurality of transactions;
obtaining query results in response to a query from a user, the query results comprising a first entity and a second entity from the plurality of individual or business entities;
identifying a subset of the plurality of transactions involving the first entity as one of a buyer and seller;
determining operational status of the first entity based on the subset of transactions comprising at least one of (i) a minimum number of transactions involving the first entity in the specified interval and (ii) a minimum aggregate amount totaling from the transactions involving the first entity in the specified interval;
presenting a modified set of query results to the user, wherein the modified set of query results includes the second entity and excludes the first entity as a result of the first subset of transactions involving the first entity not comprising at least one of the minimum number of transactions and the minimum aggregate amount.

32. (canceled)

33. (canceled)

34. A computer system comprising:
a memory storing computer-executable instructions; and
a computer processor in communication with the memory, the computer-executable instructions programming the computer processor in:
aggregating a plurality of transactions comprising a plurality of first identifiers identifying a plurality of entities as buyers and sellers to the plurality of transactions and a plurality of second identifiers identifying a plurality of locations where the plurality of transactions transpired;
identifying a subset of the plurality of transactions comprising a common first identifier identifying a same particular entity involved as one of a buyer and seller in the subset of transactions;
obtaining a first location and a second location of the particular entity;
determining operational status of the particular entity at each of the first and second locations based on the plurality of second identifiers from the subset of transactions satisfying at least one of (i) a minimum number of transactions involving the particular entity in the specified interval and (ii) a minimum aggregate amount totaling from the transactions involving the particular entity in the specified interval at each of the first and second locations; and
outputting a report from the computer system to a user, the report (i) presenting the particular entity as actively operational at the first location based on the plurality of second identifiers from the subset of transactions identifying at least one of the minimum number of transactions and the minimum aggregate amount transpiring at the particular entity first location and (ii) further presenting the particular entity as inactive and not operational at the second location based on the plurality of second identifiers from the subset of transactions not identifying at least one of the minimum number of transactions and the minimum aggregate amount transpiring at the particular entity second location.
